(19) United States
(12) Patent Application Publication
(10) Pub. No.: US 2003/0061941 A1
(43) Pub. Date: Apr. 3, 2003

(54) Whistler's best friend

(76) Inventor: Jerry Michael DeWine, Bremerton, WA (US)

Correspondence Address: Jerry Michael Dewin Jr., 3958 Hunters Circle, Jacksonville, FL, 32207, US

(21) Appl. No.: 09/810,773

(22) Filed: Sep. 10, 2001

(51) Int. Cl. A23L 1/00

(52) U.S. Cl. 99/275

(57) ABSTRACT

The Whistler's Best Friend consists of a holed, tapered rubber stopper through which passes a length of metal tubing. The device is constructed with two pieces. The first is the holed tapered rubber stopper. The second is a metal tube of approximately 7 inches in length, with an inside bend of approximately 60 degrees positioned approximately 2 inches from one end. The short end of the tube outside of the bend is then pushed into the hole on the wider end of the tapered stopper. With the device positioned in the exit spout of a steam producing device, the long piece of metal tubing is angled down in order to allow a downward discharge of steam. Another pot, cup or receptacle is then placed under the discharge end of the tubing with a substance to be heated.

### CROSS REFERENCE TO RELATED APPLICATIONS

Provisional Utility patent application information:

Jerry Michael Dewine Jr was granted a foreign filing license for the “Whistler's Best Friend” on Sep. 20, 1999. The related Provisional application filing receipt No. is 60/151,941.

The Whistler's Best Friend is an accessory device to a steam whistling pot. It consists of a holed, tapered rubber stopper through which passes a length of metal tubing. The stopper with tubing is placed in the exhaust spout of the steam whistling pot. The exiting steam is then vented through the metal tubing. The discharge end of the tubing is placed into a cup, pot or other vessel containing a substance to be heated, i.e., milk, cream, gravies, sauces, etc.

### STATEMENT REGARDING FEDERAL SPONSORING OF RESEARCH AND DEVELOPMENT

Research and development for the Whistler's Best Friend was not sponsored in whole or part by any office or any agency of the Federal Government.

TABLE OF ENCLOSURES OF THIS APPLICATION

| THE WHISTLER'S BEST FRIEND | |
|---|---|
| DESCRIPTIVE TITLE OF THE INVENTION | 1 |
| CROSS REFERENCE TO RELATED APPLICATIONS | 2 |
| STATEMENT REGARDING FEDERAL SPONSORED R & D | 3 |
| TABLE OF ENCLOSURES OF THIS APPLICATION | 4 |
| BACKGROUND OF THE INVENTION | 5 |
| BRIEF SUMMARY OF THE INVENTION | 6 |
| BRIEF DESCRIPTION OF THE DRAWINGS AND | 7 |
| PHOTOGRAPH SHOWN ON PAGE 12 | |
| DETAILED DECRIPTION | 8 |
| CLAIM(S) | 9 |
| ABSTRACT OF THE DISCLOSURE | 10, 11 |
| DRAWINGS AND A PHOTOGRAPH OF USE | 12 |
| DECLARATION | 13 |

### BACKGROUND OF THE INVENTION

The Whistler's Best Friend is a device conceived by Jerry Michael Dewine Jr. in 1996, and designed and a prototype constructed by Jerry Michael Dewine Jr. in 1999. The main intention of the device is to allow a standard kitchen item, i.e., a steam whistling tea pot, or other similar item to have the flexibility to do other tasks.

### BRIEF SUMMARY OF THE INVENTION

The Whistler's Best Friend is an accessory device to a steam whistling pot. It consists of a tapered rubber stopper with a hole centered through which passes a length of metal tubing. The stopper with tubing is placed in the exhaust spout of the steam whistling pot. The exiting steam is then vented through the metal tubing. The discharge end of the tubing is placed into a cut, pot or other vessel containing a substance to be heated, i.e., milk, cream, gravies, sauces, etc.

### BRIEF DESCRIPTION OF THE DRAWINGS AND PHOTOGRAPH ILLUSTRATED ON PAGE 12

FIG. 1A is a side view of the device showing the metal tubing through the tapered rubber stopper.

FIG. 1B is a side view of the device inserted into the exhaust spout of a whistling tea pot.

FIG. 1C is the device in use with a small pot under the discharge end of the metal tubing.

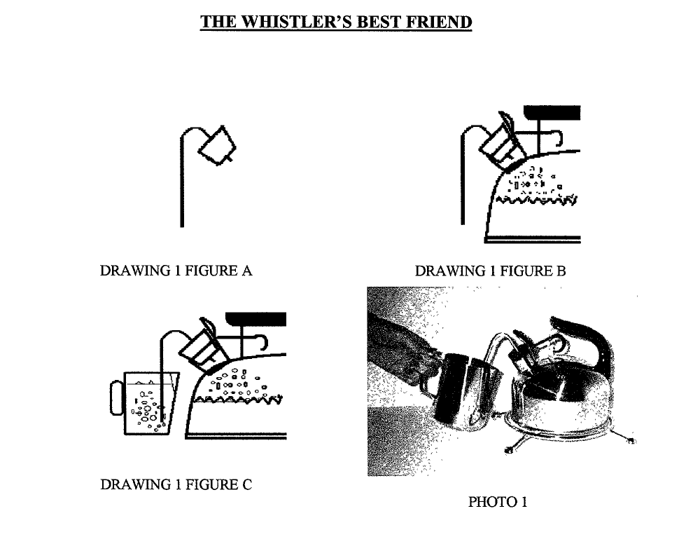

Photograph 1 is a representation of the device in use.

### DETAILED DESCRIPTION

The device is assembled using two simple components. The first component is a tapered rubber stopper with a centered hole. The second is a length of metal tubing with a bend to allow a downward discharge of the steam produced by a pot of water heated by a heat source. The short side of the metal tubing, outside of the bend, is inserted into the wider side of the tapered rubber stopper.

I Jerry Michael Dewine, Jr. claim that the device listed herein as the Whistler's Best Friend is an original idea of my own:

1. The device simply redirects the steam discharged from water heated in a pot through a metal tube in order that the steam is used to heat a substance in another receptacle.
